(19) United States
(12) Patent Application Publication
(10) Pub. No.: US 2001/0029467 A1
(43) Pub. Date: Oct. 11, 2001

(54) Commercial sales system and method using network

(76) Inventors: Toshio Yagihashi, Tokyo (JP); Shun-Ichi Sato, Tokyo (JP)

Correspondence Address: SUGHRUE, MION, ZINN, MACPEAK & SEAS, 2100 Pennsylvania Avenue, N.W., Washington, DC, 20037-3202, US

(21) Appl. No.: 09/825,337

(22) Filed: Apr. 4, 2001

(30) Foreign Application Priority Data
Apr. 5, 2000 (JP) P2000-102948

(51) Int. Cl. G06F 17/60

(52) U.S. Cl. 705/14; 705/27

(57) ABSTRACT

A commercial sales system is disclosed, which provides convenience for purchasers of items relevant to a specific item from a WWW home page, and provides profitable business to both sellers selling the specific item and sellers selling the relevant items. A specific-item catalogue and a relevant-item catalogue are registered in advance in a WWW home page. A purchaser views both catalogues via a network by using a purchaser terminal, and sends a purchase request to a relevant-item seller by designating one of the items relevant to the specific item. The relevant-item seller delivers a product of the designated item to the purchaser, and informs a settlement computer of sales data of the purchased item. The settlement computer transfers a sales commission from a sales account of the relevant-item seller to a sales account of the specific-item seller.

### BACKGROUND OF THE INVENTION

1. Field of the Invention

The present invention relates to a commercial sales system and method using a network, and in particular, to a commercial sales method for selling items relevant to a specific item via a network.

2. Description of the Related Art

Recently, novel systems have enabled purchasers to buy items from home pages on the WWW (world wide web) by using a purchaser terminal which is a data processing terminal such as a computer. In most case, purchasers want to buy various items relevant to a specific item. For example, given a specific item, such as a “portable data terminal”, there are several relevant items such as a soft case, battery, AC adapter, various kinds of connection cables, various kinds of software application resources, relevant magazines or books, and the like. If catalogs of both the specific item and the relevant items are provided on a relevant home page on the WWW, it would be very convenient for purchasers to buy such relevant items. However, actually, at present, in home pages, no relationship is established between the specific item and relevant items.

Here, such relevant items are generally sold in relation to the specific item. Therefore, it is reasonable for the relevant item seller (which sells such relevant items) to pay a commission to the specific item seller (which sells the specific item) according to the products sold. However, in actuality, no such relationship is established between the two sides.

### SUMMARY OF THE INVENTION

In consideration of the above circumstances, an objective of the present invention is to provide a commercial sales system and method using a network, which provides convenience for purchasers who wish to purchase relevant items in relation to a specific item from a home page on the WWW, and also provides profitable business to both sellers selling the specific item and sellers selling the relevant items.

Therefore, the present invention provides a commercial sales method using a network, comprising:

a step of registering in advance a specific-item catalogue relating to a specific item and a relevant-item catalogue for items relevant to the specific item in a home page on the WWW;

a step, performed by a purchaser, of viewing both the specific-item catalogue and the relevant-item catalogue on the home page via a network by using a purchaser terminal, and sending a purchase request to a relevant-item seller selling the items relevant to the specific item by designating one of the items relevant to the specific item so as to purchase the designated item;

a step, performed by the relevant-item seller, of delivering a product of the designated item to the purchaser according to the purchase request;

a step, performed by the relevant-item seller, of informing a settlement computer of sales data of the purchased item; and

a step, performed by the settlement computer, of transferring a sales commission from a sales account of the relevant-item seller to a sales account of a specific-item seller selling the specific item.

The above method may further comprise:

a step of registering purchase history data in a database, where the purchase history data indicates the history of purchased items of the purchaser; and

a step of discounting the sales commission with reference to the purchaser history data registered in the database.

The method may further comprise:

a step, performed by the specific-item seller, of sending the purchaser a request for permitting disclosure of the purchase history data; and

a step, performed by the specific-item seller, of receiving permission of the disclosure of the purchase history data from the purchaser, and providing the purchase history data of the purchaser to the relevant-item seller.

The method may further comprise:

a step, performed by the purchaser using a purchaser terminal, of sending the relevant-item seller a request for discounting the designated item on the home page; and

a step, performed by the relevant-item seller, of sending the purchaser an acceptance of the discount, and

wherein the purchaser purchases the designated item after the purchaser receives the acceptance of the discount.

The present invention also provides a commercial sales system using a network, comprising:

a register section for registering in advance a specific-item catalogue relating to a specific item and a relevant-item catalogue for items relevant to the specific item in a home page on the WWW;

a specific-item seller for selling the specific item;

a relevant-item seller for selling the items relevant to the specific item;

a purchaser terminal, operated by a purchaser, for viewing both the specific-item catalogue and the relevant-item catalogue on the home page, and sending a purchase request to the relevant-item seller by designating one of the items relevant to the specific item so as to purchase the designated item, where the relevant-item seller delivers a product of the designated item to the purchaser according to the purchase request;

a settlement computer for receiving sales data of the purchased item from the relevant-item seller, and transferring a sales commission from a sales account of the relevant-item seller to a sales account of the specific-item seller; and

a network for connecting the register section, the purchaser terminal, the relevant-item seller, the settlement computer, and the specific-item seller with each other.

The above system may further comprise:

a section for registering purchase history data in a database, where the purchase history data indicates the history of purchased items of the purchaser, and

wherein the sales commission is discounted with reference to the purchaser history data registered in the database.

The specific-item seller may includes:

a section for sending the purchaser a request for permitting disclosure of the purchase history data; and

a section for receiving permission of the disclosure of the purchase history data from the purchaser, and providing the purchase history data of the purchaser to the relevant-item seller.

It is possible that:

the purchaser terminal includes a section for sending the relevant-item seller a request for discounting the designated item on the home page;

the relevant-item seller includes a section for sending the purchaser an acceptance of the discount; and

the purchaser purchases the designated item after the purchaser receives the acceptance of the discount.

In the present invention, both the specific-item catalogue (here, a portable data terminal is assumed to be the specific item) and the relevant-item catalogue (here, optional extras, magazines, and the like relating to the portable data terminal are assumed to be the items relevant to the specific item) are viewed on a home page on the WWW. Therefore, it is possible to eliminate the inconvenience in which a purchaser who wishes to purchase optional extras or magazines of the portable data terminal must access various home pages so as to refer to 20 to 30 (or more) kinds of catalogues. In addition, when a purchaser wishes to buy a portable data terminal and accesses a home page concerning the portable data terminal, the purchaser will much more frequently access the relevant-item catalogue (showing soft cases, books, and the like) on the same home page, and may buy some relevant products (of the items), thereby promoting sales of items relevant to the specific item.

Additionally, client (i.e., purchaser) data such as sales data of a specific item is provided from the specific-item seller to the relevant-item seller; thus, the relevant-item seller can obtain strong client data used for selling the items relevant to the specific item, thereby promoting sales of the items. Therefore, the above sales commission is paid from the relevant-item seller to the specific-item seller, in compensation for the profit obtained by the relevant-item seller and the sales promotion effect of the items relevant to the specific item. In addition, the specific-item seller, by permitting the relevant-item seller to upload the relevant-item catalogue on the same home page, can also make profits from the sales commission from the relevant-item seller.

### BRIEF DESCRIPTION OF THE DRAWINGS

FIG. 1 is a diagram showing the structure of the commercial sales system as an embodiment of the present invention.

FIG. 2 is a diagram showing an example of the structure of the purchaser computer in FIG. 1

FIG. 3 is a flowchart of the operation of the embodiment shown in FIG. 1.

FIG. 4 is a diagram showing an example of the WWW home page.

FIG. 5 is a diagram showing the structure of the commercial sales system as another embodiment of the present invention.

FIG. 6 is a diagram showing an example of the data structure of the databases in the sales server.

FIG. 7 is a flowchart of the operation of the embodiment shown in FIG. 5.

FIG. 8 is a diagram showing the structure of the commercial sales system as another embodiment of the present invention.

FIG. 9 is a flowchart of the operation of the embodiment shown in FIG. 8.

FIG. 10 is a diagram showing the structure of the commercial sales system as another embodiment of the present invention.

FIG. 11 is a flowchart of the operation of the embodiment shown in FIG. 10.

### DESCRIPTION OF THE PREFERRED EMBODIMENTS

Hereinafter, embodiments according to the present invention will be explained in detail with reference to the drawings.

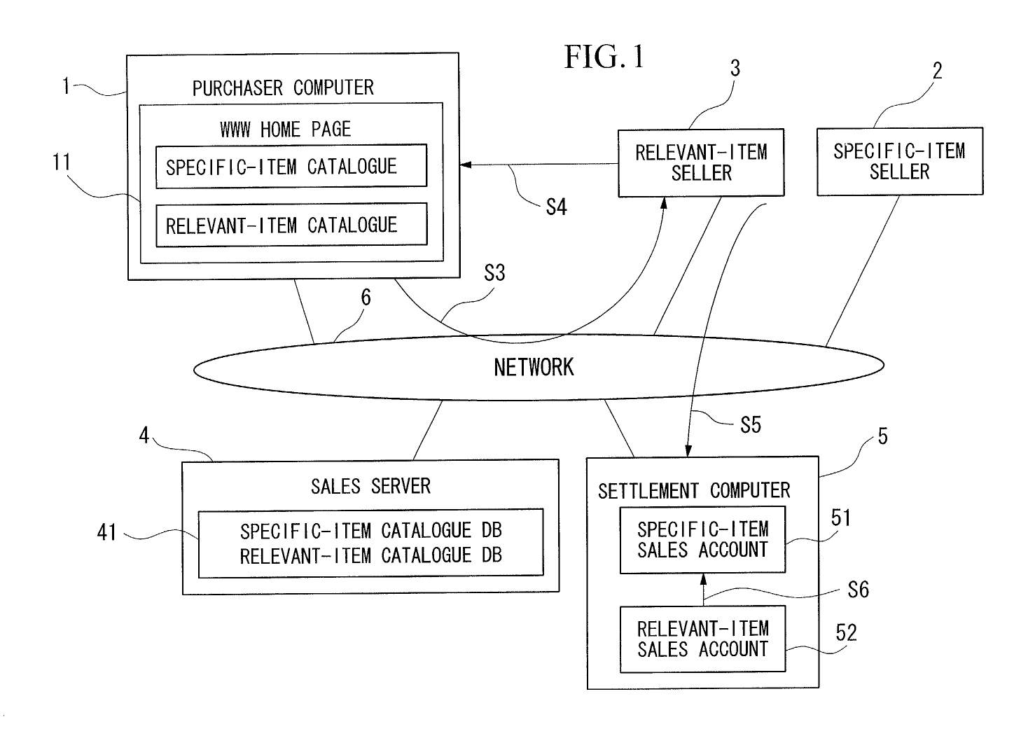

FIG. 1 is a diagram showing the structure of the commercial sales system as an embodiment of the present invention. The present system comprises (i) an item catalogue DB server (i.e., sales server) 4 for storing a specific-item catalogue database (DB) relating to a specific item (e.g., a portable data terminal) and a relevant-item catalogue DB for items relevant to the specific item (e.g., soft cases for the portable data terminal, magazines concerning the portable data terminal, and the like), where both DBs are indicated by the same reference numeral 41 in FIG. 1, (ii) a purchaser computer 1 used by a purchaser for purchasing a relevant item from a home page on the WWW (i.e., WWW home page 11), in which the catalogues of the specific item and the relevant items are shown, (iii) a specific-item seller for selling the specific item 2 (below, a seller for selling the portable data terminal), (iv) a relevant-item seller for selling items relevant to the specific item (below, a seller for selling soft cases suitable for the portable data terminal), where both sellers are different companies, (v) a settlement computer 5 by which when a relevant item is purchased, a sales commission is transferred from a relevant-item sales account 52 of the relevant-item seller to a specific-item sales account 51 of the specific-item seller, and (vi) a network 6 such as the Internet.

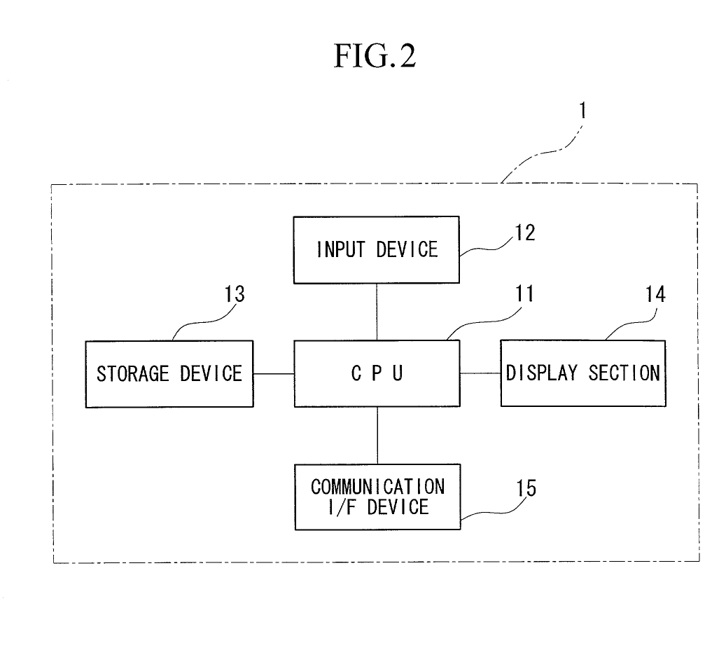

FIG. 2 shows an example of the structure of the purchaser computer 1. The structure includes an input device 12 such as a keyboard, a CPU 11 such as a microprocessor, a display section such as an LCD display, a storage device 13 for storing data, and a communication I/F (i.e., interface) device 15.

Generally, the specific-item seller 2 for selling the portable data terminal as a specific item does not sell relevant items including optional items such as soft cases, or magazines or books concerning the portable data terminal. In addition, there are 20 to 30 relevant items in relation to the portable data terminal, such as batteries, AC adapters, various kinds of connection cables, various kinds of software application resources, soft cases, magazines, books, and the like; therefore, each purchaser must access many different home pages.

Therefore, in the present invention, when a purchaser wishes to buy a portable data terminal and accesses a home page concerning the portable data terminal, relevant items (such as soft cases or books) are discussed in the same home page. Accordingly, purchasers will much more frequently access a catalogue of the relevant items, and may buy some relevant products (of the items), thereby promoting sales of relevant items.

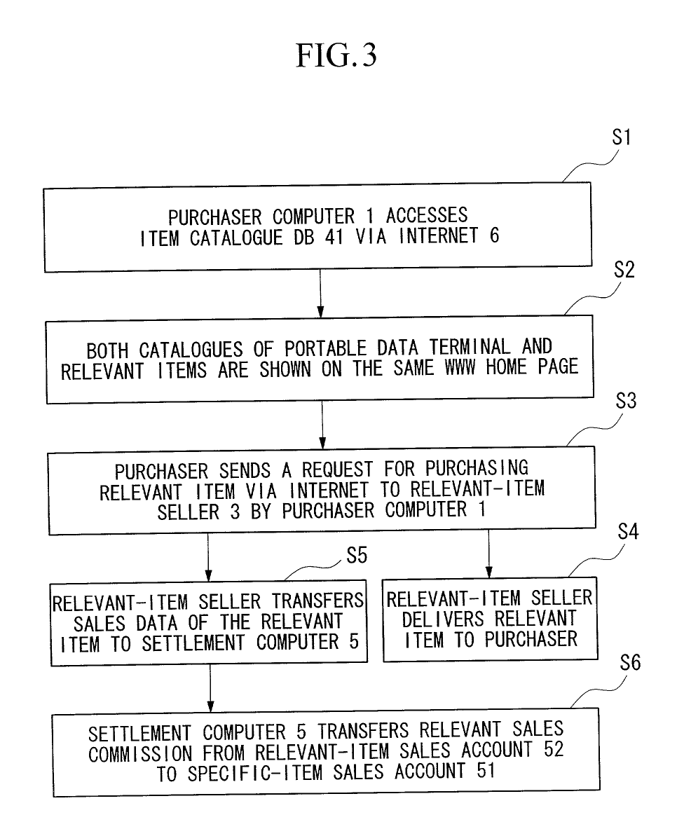

The operation of the present embodiment will be explained with reference to the flowchart in FIG. 3.

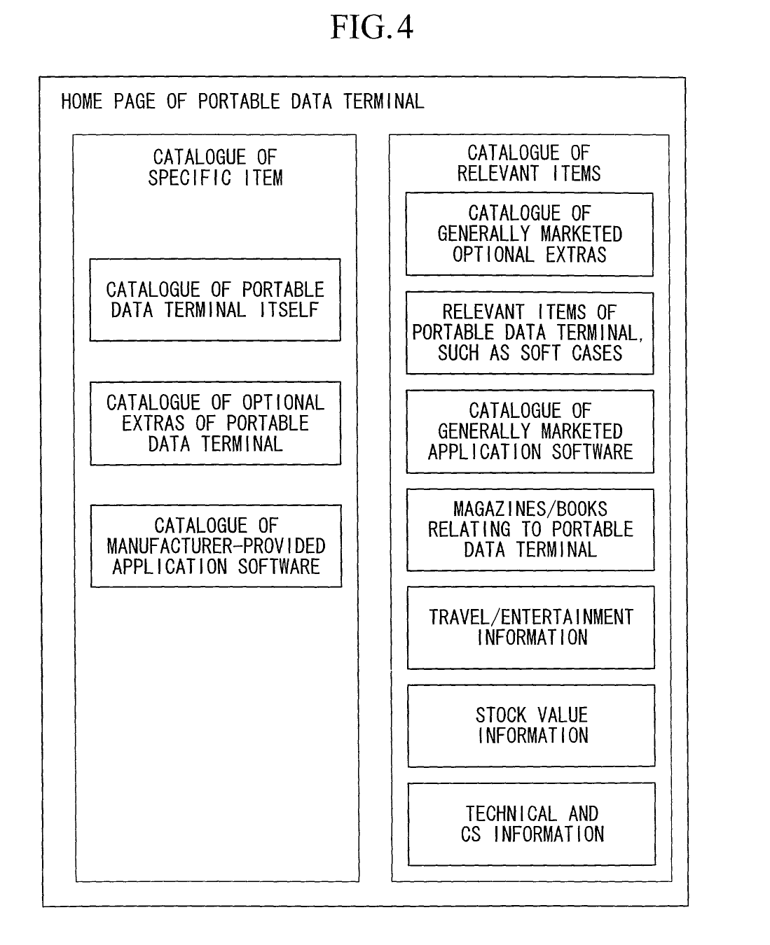

When a purchaser inputs a URL (uniform resource locator) of a home page with respect to the portable data terminal by using the input device 12 of the purchaser computer 1, the purchaser computer 1 is connected via the communication I/F device 15 to the Internet 6, and the item catalogue DB 41 is accessed (see step S1). Accordingly, relevant catalogue data are retrieved and both the catalogue of the portable data terminal and the catalogue of the relevant items (such as soft cases) are shown on the same home page, as shown in the example of the WWW home page in FIG. 4 (see step S2).

When the purchaser sends a request for purchasing a relevant item (such as a soft case) via the network 6 (here, the Internet) to the relevant-item seller 3 by using the purchaser computer 1 (see step S3), the relevant-item seller 3 delivers a relevant item product (such as a soft case) to the purchaser (see step S4).

After that, the relevant-item seller 3 transfers sales data of the purchased relevant item (such as a soft case) to the settlement computer 5 (see step S5). The settlement computer 5 performs a process of transferring a sales commission related to the purchased product (of the relevant item) from the relevant-item sales account 52 of the relevant-item seller to the specific-item sales account 51 of the specific-item seller (see step S6).

In the above explanation, soft cases or the like are shown as examples of the relevant items. However, the relevant items are not limited to those explained above, and as shown in the home page in FIG. 4, items relating to various kinds of services, such as items relating to travel/entertainment information, or items relating to technical and CS information applied to the portable data terminal, may be included. In addition, the relevant-item seller actually includes a plurality of sellers corresponding to each item, and the sellers also include a technical and CS center.

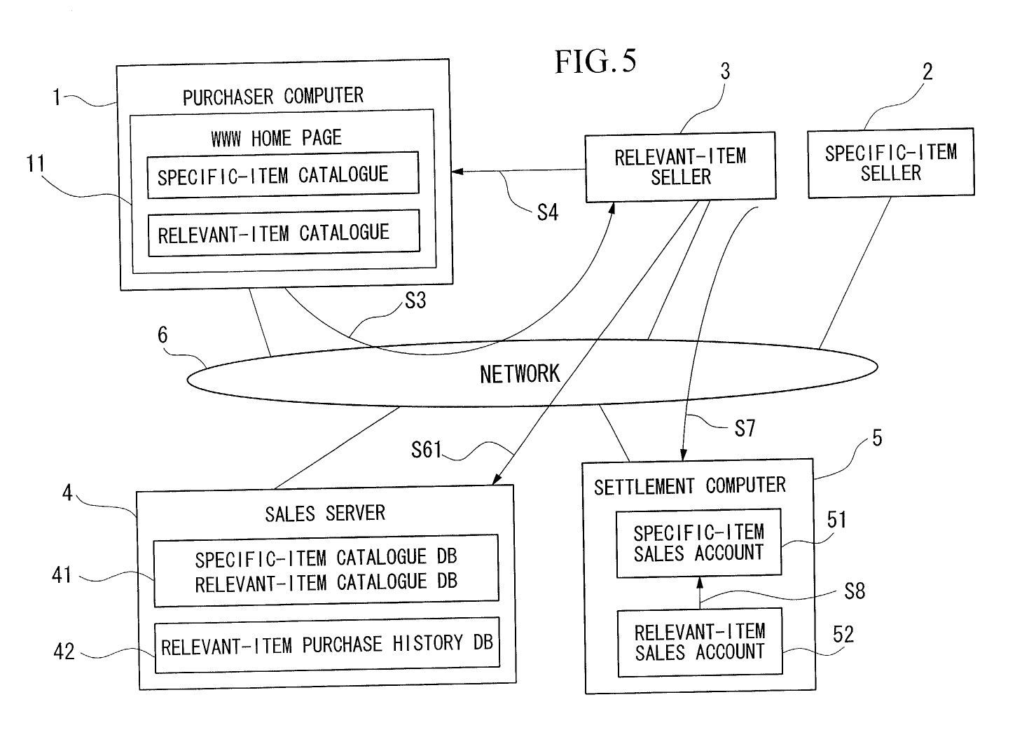

FIG. 5 shows another embodiment of the present invention, in which a relevant-item purchase history DB 42 indicating the history of purchased relevant items is stored in the sales server 4. In FIG. 5, parts identical to those in FIG. 1 are given identical reference numerals.

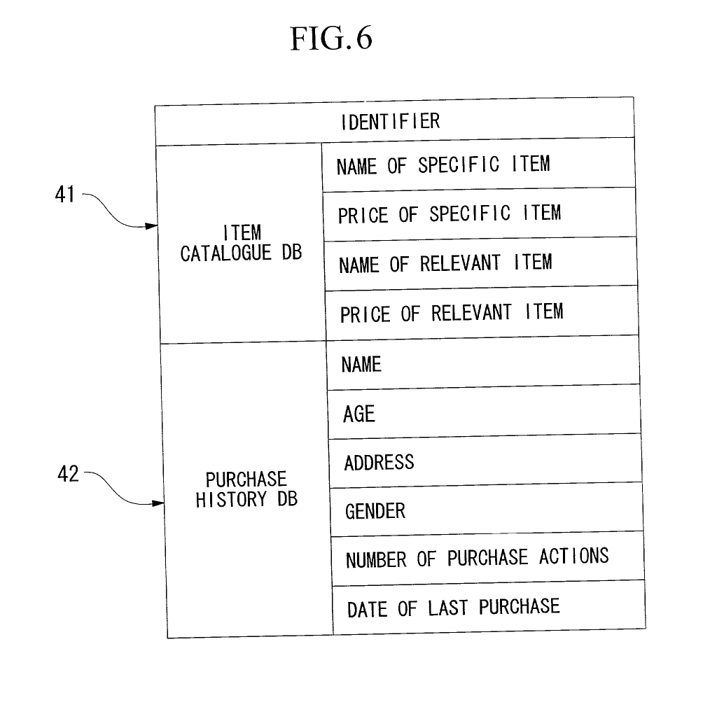

In this case, the sales commission rate can be determined (i.e., changed) by the relevant-item seller 3 according to the purchase history of each relevant item, and the sales commission may be specially discounted according to the sales results of each relevant item. FIG. 6 shows an example of the data structure of the item catalogue DB 41 and the purchase history DB 42.

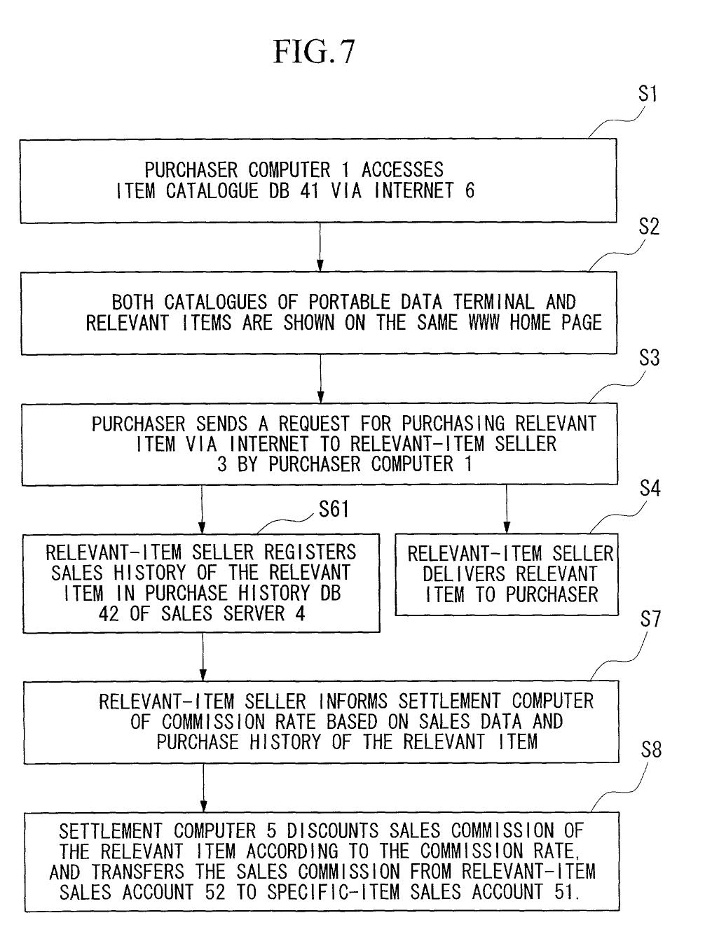

FIG. 7 is a flowchart of the operation of the embodiment shown in FIG. 5. In FIG. 7, the steps same as those in FIG. 3 are given identical step numbers, and thus the processes of step S1 to S4 are the same as those in FIG. 3.

In step S61, the relevant-item seller 3 registers sales history (data) with respect to the relevant item (such as a soft case) in the purchase history DB 42 of the sales server 4 (refer to FIG. 6). In the following step S7, the relevant-item seller 3 informs the settlement computer 5 of a commission rate determined based on the sales data and purchase history of the relevant item.

In the next step S8, the settlement computer 5 discounts the sales commission of the relevant item according to the commission rate, and transfers the discounted sales commission from the relevant-item sales account 52 to the specific-item sales account 51.

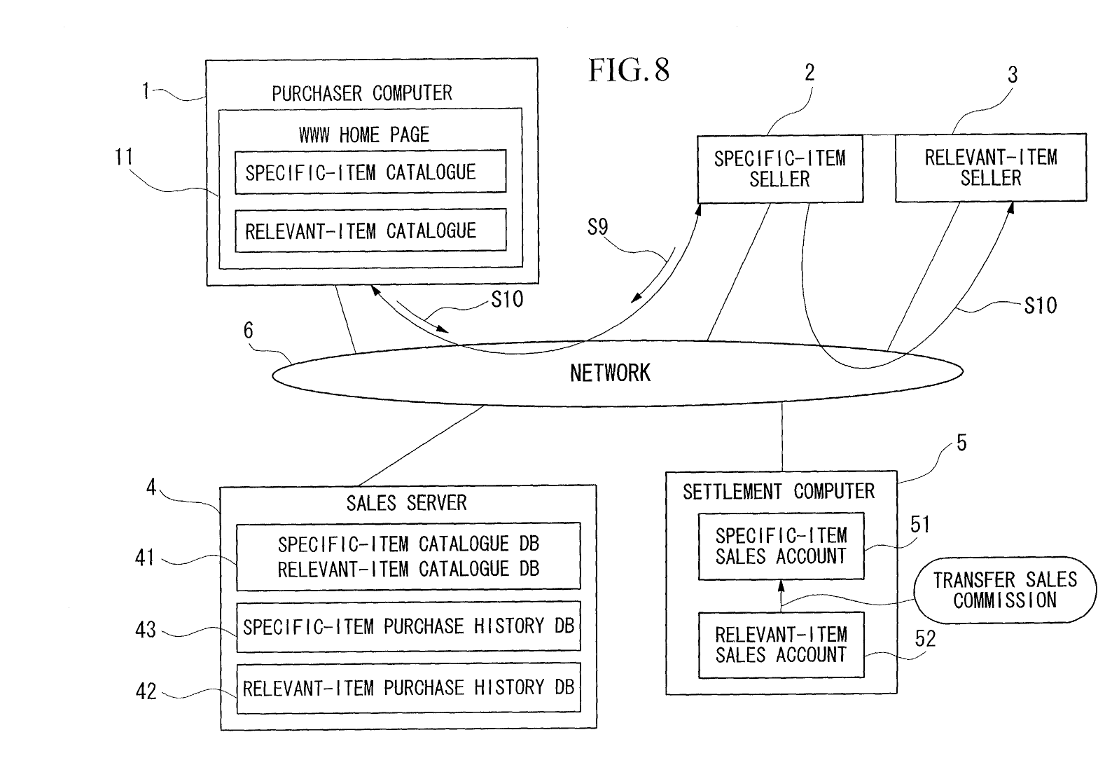

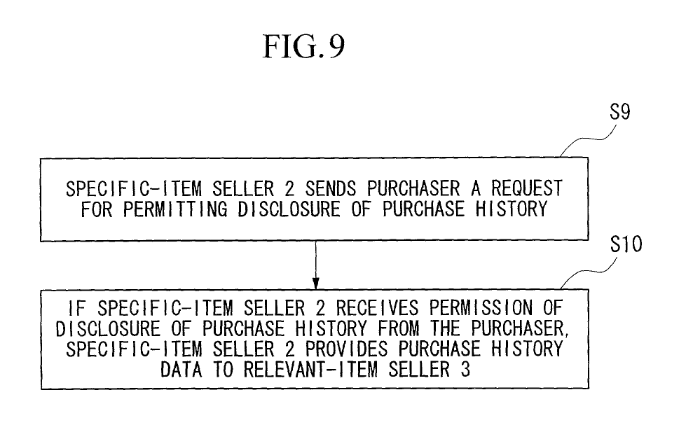

FIG. 8 shows another embodiment of the commercial sales system according to the present invention, and FIG. 9 shows the flowchart of the operation of this embodiment. In FIG. 8 parts identical to those in FIG. 1 are given identical reference numerals.

In this embodiment, the specific-item seller 2 sends a purchaser a request for permitting disclosure of the purchase history of the purchaser (see step S9). After the specific-item seller 2 receives permission of disclosure of the purchase history from the purchaser, the specific-item seller 2 provides the purchase history (data) of the purchaser to the relevant-item seller 3 (see step S10). In this case, the purchase history data include a specific-item purchase history DB 43 in addition to the relevant-item purchase history DB 42.

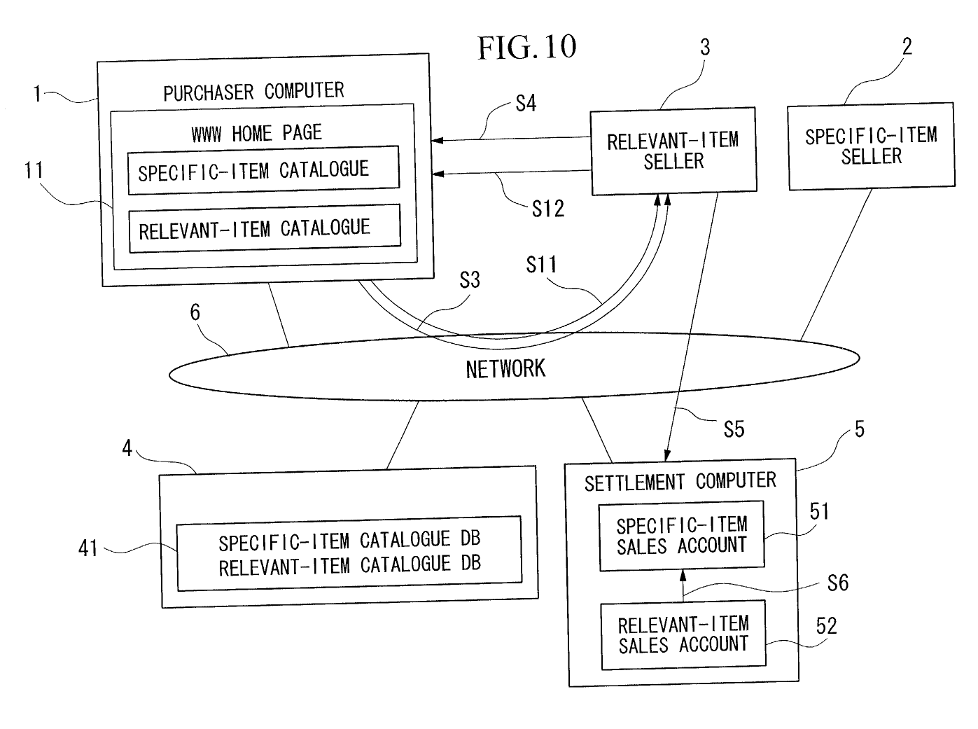

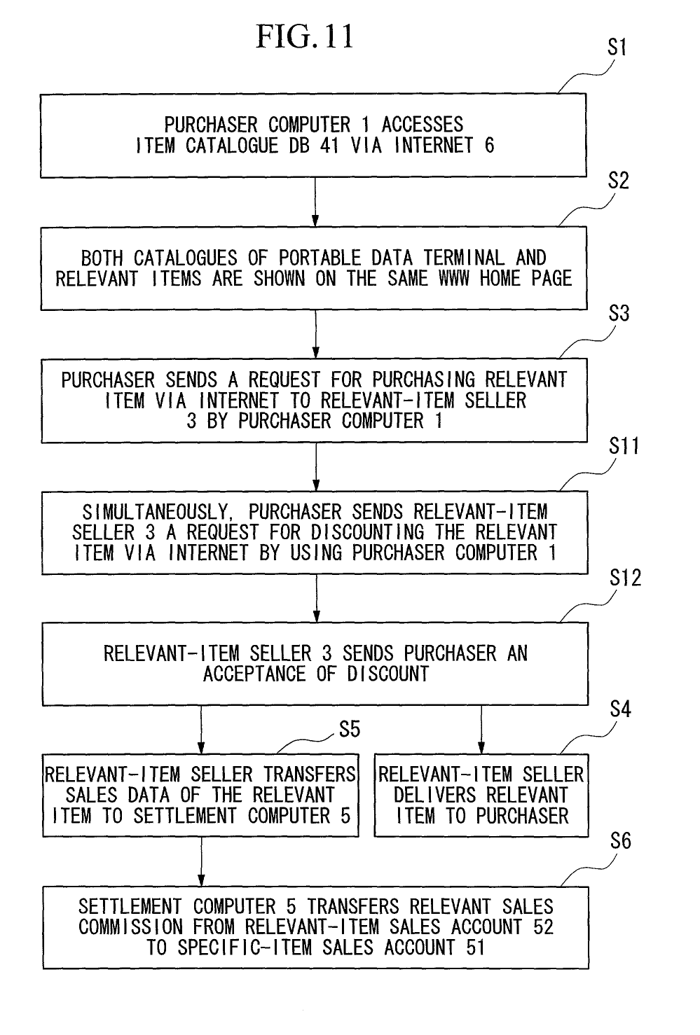

FIG. 10 shows another embodiment of the commercial sales system according to the present invention, and FIG. 11 shows the flowchart of the operation of this embodiment. In FIG. 10, parts identical to those in FIG. 1 are given identical reference numerals, and in FIG. 11, the same steps as those in FIG. 3 are given identical step numbers.

In this embodiment, the purchaser sends the relevant-item seller 3 a request for discounting the relevant item (see step S11), and the relevant-item seller 3 sends the purchaser an acceptance of the discount (see step S12), and then a relevant product is delivered.

What is claimed is:

1. A commercial sales method using a network, comprising:
a step of registering in advance a specific-item catalogue relating to a specific item and a relevant-item catalogue for items relevant to the specific item in a home page on the WWW;
a step, performed by a purchaser, of viewing both the specific-item catalogue and the relevant-item catalogue on the home page via a network by using a purchaser terminal, and sending a purchase request to a relevant-item seller selling the items relevant to the specific item by designating one of the items relevant to the specific item so as to purchase the designated item;
a step, performed by the relevant-item seller, of delivering a product of the designated item to the purchaser according to the purchase request;
a step, performed by the relevant-item seller, of informing a settlement computer of sales data of the purchased item; and
a step, performed by the settlement computer, of transferring a sales commission from a sales account of the relevant-item seller to a sales account of a specific-item seller selling the specific item.

2. A commercial sales method as claimed in claim 1, further comprising:
a step of registering purchase history data in a database, where the purchase history data indicates the history of purchased items of the purchaser; and
a step of discounting the sales commission with reference to the purchaser history data registered in the database.

3. A commercial sales method as claimed in claim 2, further comprising:
a step, performed by the specific-item seller, of sending the purchaser a request for permitting disclosure of the purchase history data; and
a step, performed by the specific-item seller, of receiving permission of the disclosure of the purchase history data from the purchaser, and providing the purchase history data of the purchaser to the relevant-item seller.

4. A commercial sales method as claimed in any one of claims 1 to 3, further comprising:
a step, performed by the purchaser using a purchaser terminal, of sending the relevant-item seller a request for discounting the designated item on the home page; and
a step, performed by the relevant-item seller, of sending the purchaser an acceptance of the discount, and
wherein the purchaser purchases the designated item after the purchaser receives the acceptance of the discount.

5. A commercial sales system using a network, comprising:
a register section for registering in advance a specific-item catalogue relating to a specific item and a relevant-item catalogue for items relevant to the specific item in a home page on the WWW;
a specific-item seller for selling the specific item;
a relevant-item seller for selling the items relevant to the specific item;
a purchaser terminal, operated by a purchaser, for viewing both the specific-item catalogue and the relevant-item catalogue on the home page, and sending a purchase request to the relevant-item seller by designating one of the items relevant to the specific item so as to purchase the designated item, where the relevant-item seller delivers a product of the designated item to the purchaser according to the purchase request;
a settlement computer for receiving sales data of the purchased item from the relevant-item seller, and transferring a sales commission from a sales account of the relevant-item seller to a sales account of the specific-item seller; and
a network for connecting the register section, the purchaser terminal, the relevant-item seller, the settlement computer, and the specific-item seller with each other.

6. A commercial sales system as claimed in claim 5, further comprising:
a section for registering purchase history data in a database, where the purchase history data indicates the history of purchased items of the purchaser, and
wherein the sales commission is discounted with reference to the purchaser history data registered in the database.

7. A commercial sales system as claimed in claim 6, wherein the specific-item seller includes:
a section for sending the purchaser a request for permitting disclosure of the purchase history data; and
a section for receiving permission of the disclosure of the purchase history data from the purchaser, and providing the purchase history data of the purchaser to the relevant-item seller.

8. A commercial sales system as claimed in any one of claims 5 to 7, wherein:
the purchaser terminal includes a section for sending the relevant-item seller a request for discounting the designated item on the home page;
the relevant-item seller includes a section for sending the purchaser an acceptance of the discount; and
the purchaser purchases the designated item after the purchaser receives the acceptance of the discount.
